(19) United States
(12) Patent Application Publication
(10) Pub. No.: US 2006/0007969 A1
(43) Pub. Date: Jan. 12, 2006

(54) Short pulse optical interconnect

(76) Inventors: Brandon C. Barnett, Beaverton, OR (US); Bruce A. Block, Portland, OR (US)

Correspondence Address: INTEL CORPORATION, P.O. BOX 5326, SANTA CLARA, CA, 95056-5326, US

(21) Appl. No.: 10/816,592

(22) Filed: Mar. 31, 2004

(51) Int. Cl. H01S 3/10

(52) U.S. Cl. 372/26; 372/25

(57) ABSTRACT

A pulse laser generates a pulse train. A modulator receives the pulse train and a data signal. The modulator encodes the data signal onto the pulse train by selectively passing pulses.

### FIELD OF THE INVENTION

The present invention relates to the field of optical communications. More specifically, the present invention relates to an optical interconnect using short pulses.

### BACKGROUND

Optical communications usually involve modulating an optical carrier. A common optical carrier is a light beam from a laser. A laser beam can be modulated by turning the laser on and off, or by selectively redirecting the beam. By modulating a beam in particular patterns, a beam can be encoded with data to convey information.

A common example of optical communications is a fiber optic telephone network. At each end of a telephone conversation, sound can be captured and turned into an electrical signal. The electrical signal can be converted into an optical signal by modulating a laser beam. The modulated beam can be directed down an optical fiber. A photodetector at the other end of the optical fiber can convert the modulated light back into an electrical signal, and the electrical signal can be converted back into sound. The same basic process can be used to convey virtually any kind of information on virtually any scale, be it within a microchip, from microchip to microchip, from computer to computer, across the country, or around the world.

Optical communications can provide a number of advantages over electrical communications. For example, optical signals are largely immune to electric and magnetic interference, making for much “cleaner” signals. As a result, optical communications can be much faster than electrical communications because there is less noise or static to drown out the data. Even in optical communications though, the data usually start out as electrical signals. In which case, the biggest limiting factor to the speed and quality of optical communications often comes from the electrical equipment.

For instance, turning a laser on or off, or redirecting a laser beam, takes the electrical equipment a certain amount of time. That is, rather than crisp, instantaneous transitions between on and off, the amplitude of an optical carrier will ramp up and down over time as it is modulated by the electrical equipment. When the data rate is high compared to this transition time, the carrier amplitude may look like a sinusoid, drifting from one data state to the next. The more gradual and less distinct the slope of this transition is, the more the quality of the signal suffers.

### BRIEF DESCRIPTION OF DRAWINGS

Examples of the present invention are illustrated in the accompanying drawings. The accompanying drawings, however, do not limit the scope of the present invention. Similar references in the drawings indicate similar elements.

FIG. 1 illustrates one embodiment of data and carrier signals.

FIG. 2 illustrates one embodiment of the present invention.

FIGS. 3-6 illustrate various embodiments of pulse train modulation.

### DETAILED DESCRIPTION OF THE INVENTION

In the following detailed description, numerous specific details are set forth in order to provide a thorough understanding of the present invention. However, those skilled in the art will understand that the present invention may be practiced without these specific details, that the present invention is not limited to the depicted embodiments, and that the present invention may be practiced in a variety of alternative embodiments. In other instances, well known methods, procedures, components, and circuits have not been described in detail. Parts of the description will be presented using terminology commonly employed by those skilled in the art to convey the substance of their work to others skilled in the art. Repeated usage of the phrase “in one embodiment” does not necessarily refer to the same embodiment, although it may.

Embodiments of the present invention can provide crisp, almost instantaneous state transitions in optical communications for a wide range of data rates. Rather than using an optical carrier signal that is a continuous wave, embodiments of the present invention use an optical pulse train as a carrier signal. This pulse train carrier signal can be modulated with data by selectively passing pulses.

A pulse train can be created using a pulse laser, also called a mode-locked laser. By appropriately selecting the physical properties of a laser, the laser can be made to naturally generate highly uniform pulses of light at a highly uniform pulse frequency and duty ratio (ratio of light-to-no-light per cycle). By designing lasers with different physical properties, pulse trains can be achieved for a wide range of pulse frequencies and duty ratios. A pulse laser's energy for each cycle of the pulse train is concentrated into the pulse. So, for a given pulse frequency and laser power, the smaller the duty ratio, the higher the amplitude of the pulse. Very short pulses can be designed that approach the characteristics of an impulse function, with almost infinite slope.

Embodiments of the present invention can use these short pulses to achieve almost instantaneous state transitions. The electrical modulation of the carrier is only needed to selectively pass pulses. In other words, rather than relying on the electrical modulation of the optical carrier to provide the slope of a transition, the optical carrier itself can provide the slope. Using short pulses, embodiments of the present invention can not only improve signal quality, but can also reduce power compared to a continuous wave optical carrier.

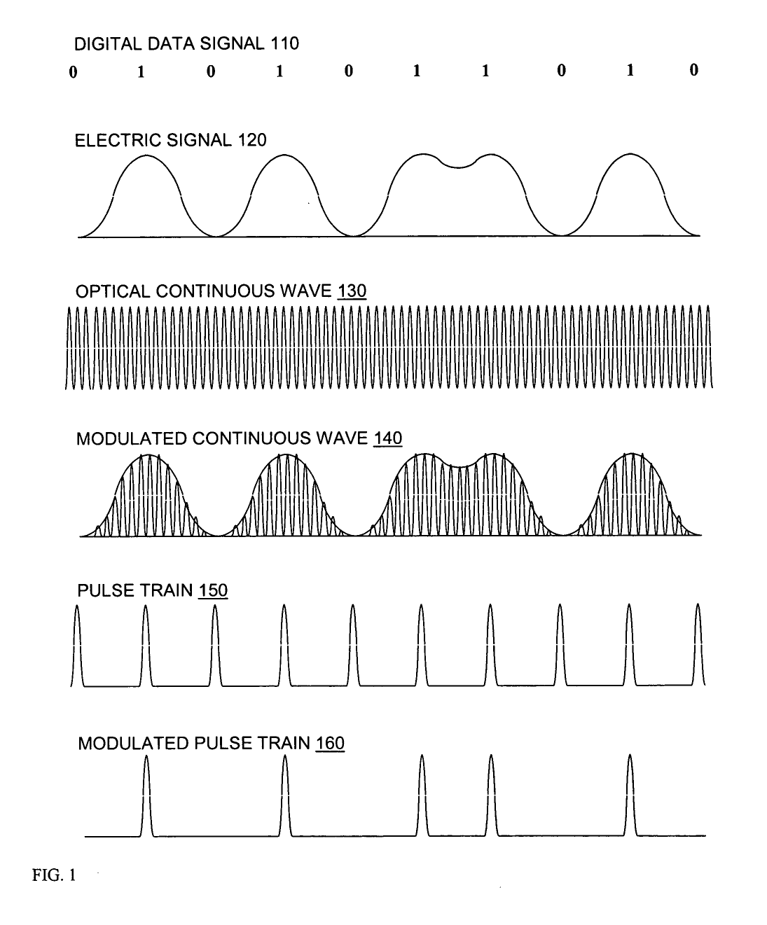

FIG. 1 illustrates one embodiment of a digital data signal 110, a corresponding electrical signal 120, an optical continuous wave 130, a corresponding modulated continuous wave 140, a pulse train 150, and a corresponding modulated pulse train 160. Data signal 110 comprises a series of one's and zero's. The corresponding electrical signal 120 represents the one's with a higher voltage level and represents the zero's with a lower voltage level. In other embodiments, the electrical signal can represent the data in any of a number of ways.

Optical continuous wave 130 comprises an optical frequency signal. That is, the wavelength and frequency of the signal are based on the color of the laser light. Optical frequencies tend to be in the Terahertz range. Electrical signals tend to be in the Megahertz or Gigahertz range. In which case, each bit represented by an electrical signal may occupy many thousands of optical wavelengths.

Modulated continuous wave 140 illustrates how continuous wave carrier 130 might be modulated to represent data 110. The electrical signal 120 can be combined with continuous wave 130, forming an envelope filled by the continuous wave. As with the electrical signal, one's can be represented by high amplitudes of the carrier and zero's can be represented by low amplitudes of the carrier.

The modulation can be accomplished in any of a number of ways. For instance, the electrical signal 120 could be used to directly drive a laser die generating the carrier. Or, the electrical signal 120 could be used to drive a variable optical attenuator or a Mach-Zhender modulator to manipulate the amplitude of the carrier wave after it is generated by a laser die.

In each of these cases, the slope of a transition from one data state to another is determined by the slope of the electrical signal that controls the modulation. Moreover, noise on the electrical signal can change the shape of the carrier's envelope, degrading the quality of the optical signal.

Pulse train 150 illustrates one embodiment of a pulse train that may be generated by a pulse laser. Different laser designs can produce different kinds of pulse trains, with different pulse widths and different pulse frequencies. Pulses can be made quite short, having, for instance, on the order of 100 optical wavelengths per pulse.

Modulated pulse train 160 illustrates how pulse train 150 may be modulated to represent data 110. The electrical signal 120 can be used to selectively pass pulses from pulse train 150. By tuning the data rate of the electrical signal to the pulse rate of the pulse train, each cycle can represent one bit of data. One's can be represented by the presence of a pulse in a cycle, and zero's can be represented by the absence of a pulse in a cycle. Other embodiments may represent data with pulses in any of a number of ways, such as various patterns of pulses representing various types of data.

Any of a number of approaches can be used to selectively pass pulses. For example, the same variable optical attenuator or Mach-Zhender modulator that can be used to modulate a continuous wave carrier can also be used selectively pass pulses.

No matter what kind of modulation is used for the pulse train, the slope of a transition from one data state to another is likely to be the slope of the carrier's pulse. With this steep slope, transitions can be almost instantaneous. In which case, noise on the electrical signal is likely to have little or no effect on the quality of the optical signal.

In addition to improved signal quality, pulse train modulation can reduce the average power of optical communications. For example, a photodetector may require 100 milliwatts of optical power to register a logical one. In which case, a continuous wave carrier may need to operate at a continuous average power of over 100 milliwatts. The power from each cycle of a pulse train, however, is concentrated into the pulse. So, for instance, if the duty ratio of a pulse train is 1 to 100, the amplitude of the pulse may be about 100 times the amplitude of a continuous wave having the same average power. In which case, the average power of the pulse train could theoretically be reduced to just 1 milliwatt and still produce pulses of 100 milliwatts that can be detected by the photodetector.

Put another way, in the case of a 10 gigahertz data rate, each cycle is about 100 picoseconds long. A continuous wave carrier may generate a 100 milliwatt signal throughout all 100 picoseconds of each cycle. In contrast, a pulse train with a 1 to 100 duty ratio may generate a 100 milliwatt signal for just 1 picosecond of each cycle.

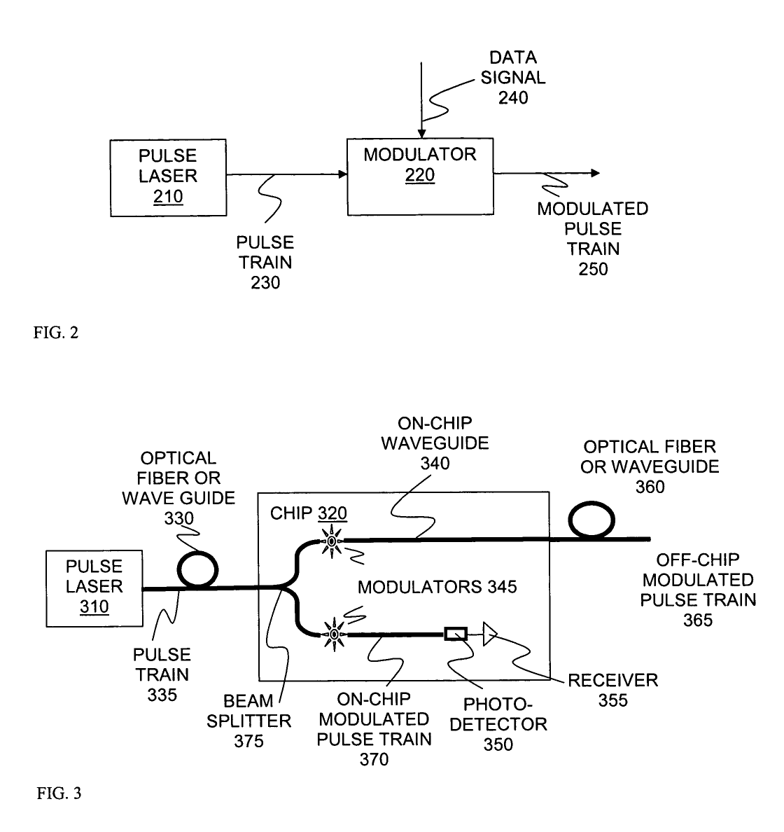

FIG. 2 illustrates one embodiment of the present invention. A pulse laser 210 generates a pulse train 230 that is received by modulator 220. Modulator 220 also receives a data signal 240 which modulator 220 uses to selectively pass pulses from pulse train 230 to generate modulated pulse train 250. These basic components can be used in a wide variety of configurations and applications. A few examples are shown below in FIGS. 3 through 6.

FIG. 3 illustrates one embodiment of pulse train modulation for on-chip and/or off-chip communications. Pulse laser 310 generates pulse train 335. An optical conductor directs the pulse train to chip 320. Any of a number of optical conductors can be used. In the illustrated embodiment, the optical conductor is either an optical fiber or a waveguide. Other embodiments may use a combination of both.

Chip 320 could be any of a number of devices, such as a microprocessor, a digital signal processor (DSP), a application-specific integrated circuit (ASIC), a programmable gate array (PGA), or the like. In any case, chip 320 includes modulators 345. In alternate embodiments, one or both of the modulators could be discreet components separate from chip 320.

Beam splitter 375 provides pulse train 335 to both modulators 345 through various on-chip waveguides 340. Chip 320 generates or receives data signals (not shown) to drive the modulators to encode data onto the pulse trains by selectively passing pulses.

On-chip modulated pulse train 370 is received by photodetector 350, which generates electric current in response to photons. Each pulse from modulated pulse train 370 can generate a current of electrons that can be interpreted as data by receiver 355. Other embodiments may use any of a number of different approaches to capture or make use of the data, including various forms of pure optical processing.

Off-chip modulated pulse train 365 travels out of chip 320. Modulated pulse train 365 could be used in any of a number of ways, and could travel to any number of other components.

In other embodiments, rather than using optical conductors, such as optical fibers and waveguides, the beams can simply travel through open space. Also, in other embodiments, additional beam splitters could be used to supply pulse train 335 to any number of individual or arrayed modulators, both in chip 320 as well as outside chip 320. Any of a number of beam splitting devices could be used.

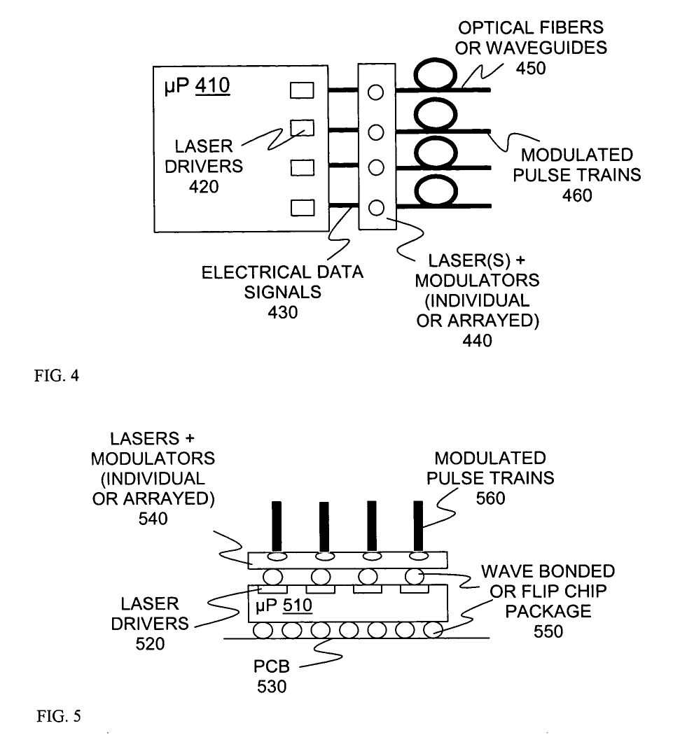

FIG. 4 illustrates another embodiment of pulse train modulation. In the illustrated embodiment, microprocessor 410 includes a number of laser drivers 420. The laser drivers could each represent independent signals generated by microprocessor 410, or an array of two or more of the laser drivers could operate together to drive a multi-bit bus.

In any case, electrical data signals 430 from drivers 420 are supplied to laser unit 440. Laser unit 440 generates modulated pulse trains 460 on optical fibers or waveguides 450. Laser unit 440 may comprise a number of modulators (not shown), one for each of the data signals 430, and at least one pulse laser (not shown) to feed the modulators. The modulators may be arranged in an array or they may operate independently. In the case of an array, a single pulse laser may be adequate to feed all of the modulators. In the case of independently operated modulators, a separate pulse laser may be needed for each modulator. Laser unit 440 may comprise a single chip, or it may comprise a number of discreet components, or it may comprise some combination of one or more discreet components and one or more chips.

FIG. 5 illustrates another embodiment of pulse train modulation. Microprocessor 510 is coupled to printed circuit board 530, and laser unit 540 is coupled to microprocessor 510. The coupling 550 between the components could be, for instance, wave bonded or a flip chip package. Microprocessor 510 includes a number of laser drivers 520 which drive modulators (not shown) in laser unit 540. Laser unit 540 includes at least one pulse laser (not shown) to feed the modulators. As in FIG. 4, the laser drivers, modulators, and pulse laser(s) can take any of a number of forms and configurations. In any case, laser unit 540 generates modulated pulse trains 560.

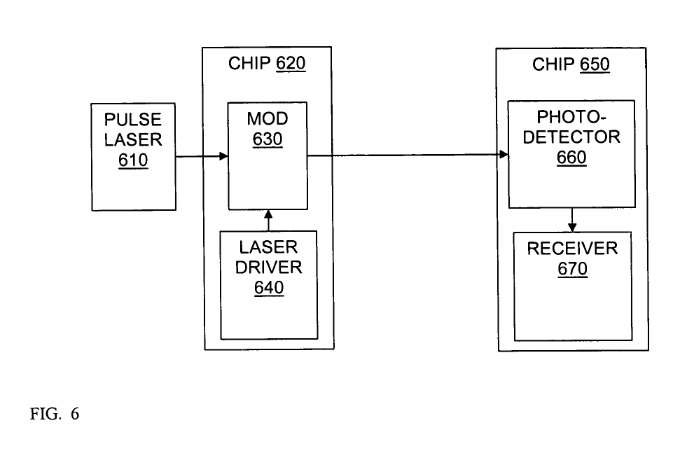

FIG. 6 illustrates one embodiment of chip-to-chip pulse train communications. Chip 620 includes a modulator 630 that is fed by pulse laser 610 and driven by laser driver 640. Chip 650 receives the modulated pulse train from chip 620. Photodetector 660 can generate electric current for each pulse that is received. Receiver 670 can interpret the electric as data. In other embodiments, pulse laser 610 may be part of chip 620 and laser driver 640 may be separate from chip 620.

FIGS. 2 through 6 illustrate a number of specific examples of the present invention. Alternate embodiments may arrange components differently, may include additional components, may include fewer components, and may combine one or more components.

Thus, a short pulse optical interconnect is described. Whereas many alterations and modifications of the present invention will be comprehended by a person skilled in the art after having read the foregoing description, it is to be understood that the particular embodiments shown and described by way of illustration are in no way intended to be considered limiting. Therefore, references to details of particular embodiments are not intended to limit the scope of the claims.

What is claimed is:

1. An apparatus comprising:
a pulse laser to generate a pulse train; and
a modulator to receive the pulse train and a data signal, said modulator to encode the data signal onto the pulse train by selectively passing pulses.

2. The apparatus of claim 1 wherein the pulse laser is mode-locked to a particular pulse frequency equal to a data rate of the data signal.

3. The apparatus of claim 1 wherein the pulse laser is mode-locked to a particular duty ratio of light-to-no-light per pulse cycle.

4. The apparatus of claim 3 wherein the duty ratio comprises 1 to 100.

5. The apparatus of claim 1 wherein the modulator comprises one of a Mach-Zhender interferometer or a variable optical attenuator.

6. The apparatus of claim 1 further comprising:
a light conductor to direct the pulse train from the pulse laser to the modulator.

7. The apparatus of claim 6 wherein the light conductor comprises at least one of a waveguide or an optical fiber.

8. The apparatus of claim 1 wherein:
the modulator comprises one of a plurality of modulators, each of the plurality of modulators to separately receive the pulse train and a separate data signal, and to encode the separate data signal onto the pulse train by selectively passing pulses.

9. The apparatus of claim 8 further comprising:
a waveguide splitter to direct the pulse train from the pulse laser to the plurality of modulators.

10. The apparatus of claim 1 wherein:
the pulse laser comprises one of a plurality of pulse lasers, each of the plurality of pulse lasers to generate a separate pulse train; and
the modulator comprises one of a plurality of modulators, each of the plurality of modulators to receive one of the separate pulse trains and a separate data signal, and to encode the separate data signal onto the respective separate pulse train by selectively passing pulses.

11. The apparatus of claim 1 further comprising:
a photodetector to receive the modulated pulse train from the modulator and convert the modulated pulse train to a modulated electrical current; and
a receiver to convert the modulated electrical current back into the data signal.

12. The apparatus of claim 11 wherein the modulator comprises a first chip and the photodetector and the receiver comprise a second chip.

13. The apparatus of claim 11 wherein the modulator, the photodetector, and the receiver comprise a chip.

14. A system comprising:
a pulse laser to generate a pulse train;
a first chip to receive the pulse train and a data signal, and to modulate the data signal onto the pulse train by selectively passing pulses; and
a second chip to receive the modulated pulse train from the first chip, convert the modulated pulse train to a modulated electrical current, and convert the modulated electrical current back into the data signal.

15. The system of claim 14 further comprising:
a light conductor to direct the modulated pulse train from the first chip to the second chip.

16. The system of claim 14 wherein:
the first chip comprises a plurality of modulators, each of the plurality of modulators to separately receive the pulse train and a separate data signal, and to encode the separate data signal onto the pulse train by selectively passing pulses.

17. The system of claim 16 further comprising:
a waveguide splitter to direct the pulse train from the pulse laser to the plurality of modulators.

18. The system of claim 14 wherein the pulse laser is integrated into the first chip, and wherein:
the pulse laser comprises one of a plurality of pulse lasers integrated into the first chip, each of the plurality of pulse lasers to generate a separate pulse train; and
the first chip comprises a plurality of modulators, each of the plurality of modulators to receive one of the separate pulse trains and a separate data signal, and to encode the separate data signal onto the respective separate pulse train by selectively passing pulses.

19. A method comprising:
generating an optical pulse train;
receiving a data signal; and
modulating the optical pulse train to encode the data signal onto the pulse train by selectively passing pulses.

20. The method of claim 19 further comprising:
tuning a data frequency of the data signal to be equal to a pulse frequency of the optical pulse train.
